(19) United States
(12) Patent Application Publication
(10) Pub. No.: US 2011/0016247 A1
(43) Pub. Date: Jan. 20, 2011

(54) MULTIPROCESSOR SYSTEM AND MULTIPROCESSOR SYSTEM INTERRUPT CONTROL METHOD

(75) Inventor: Takashi Ohmasa, Osaka (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/892,136

(22) Filed: Sep. 28, 2010

Related U.S. Application Data
(63) Continuation of application No. PCT/JP2009/001285, filed on Mar. 24, 2009.

(30) Foreign Application Priority Data
Apr. 3, 2008 (JP) 2008-097226

(51) Int. Cl. G06F 13/26

(52) U.S. Cl. 710/264

(57) ABSTRACT

A multiprocessor system, which improves processing efficiency of an entire system while concurrently securing appropriate interrupt responsivity according to interrupt priority, includes a plurality of processors each including a register, a plurality of I/O devices, and an interrupt generation device. A multiprocessor system interrupt control method includes: setting, for the register, interrupt permissibility indicating permissibility for an interrupt to be permitted by a corresponding processor; receiving an interrupt request from one of the I/O devices, using the interrupt generation device having a memory which holds the interrupt priority indicating the priority for the interrupt from each I/O device, and notifying the interrupt request from I/O device and the interrupt priority to the plurality of processors; and causing one of the processors that includes the register holding interrupt permissibility lower than the interrupt priority to accept the interrupt request.

### CROSS REFERENCE TO RELATED APPLICATION

This is a continuation application of PCT application No. PCT/W2009/001285, filed on Mar. 24, 2009, designating the United States of America.

### BACKGROUND OF THE INVENTION

(1) Field of the Invention

The present invention relates to multiprocessor systems and multiprocessor system interrupt control methods, and relates in particular to a multiprocessor system and a multiprocessor system interrupt control method which control interrupts.

(2) Description of the Related Art

A typical multiprocessor system includes: processors which can perform interrupt processing; a shared bus; a shared memory which is accessible from the processors via the shared bus; and an interrupt generation device which notifies the processor of a signal from an Input/Output (I/O) device that is a device for inputting and outputting data as an interrupt signal.

Here, an interrupt is to cause other processing to be performed during a certain sequence of processing.

In the typical multiprocessor system, an interrupt is caused by a signal from the I/O device, and a responsibility for processing the interrupt is assigned to one of the processors included in the multiprocessor system. The processor, which is assigned with the responsibility, suspends the processing that it has been performing till then, and performs interrupt processing.

Here, an example of the multiprocessor system which performs interrupt control is a multiprocessor system which notifies an interrupt to all the processors and assigns the responsibility for interrupt processing to the processor that receives the notice earliest.

Generally, an interrupt control method for such a multiprocessor system achieves a sufficient responsivity in terms of a length of time from when the interrupt occurs to when the processor starts interrupt processing. However, this involves, for other processors that are not the processor assigned with the interrupt processing, a process of cancelling the interrupt processing for the interrupt notice, thus resulting in decrease in processing efficiency of the entire system.

Thus, another example of the multiprocessor system which performs interrupt control is a multiprocessor system which previously assigns the responsibility for interrupt processing to a specific processor, and notifies an interrupt to the specific processor assigned with the responsibility when the interrupt occurs.

FIG. 31 is a block diagram showing a configuration of a multiprocessor system which performs a conventional interrupt control. The multiprocessor system shown in FIG. 31 includes: processors 3101, 3102, 3103, and 3104 capable of performing interrupt control; a shared bus 3110; a shared memory 3120 accessible via the shared bus 3110; an interrupt generation device 3130; I/O devices 141, 142, and 143; and an I/O interface 170.

The interrupt generation device 3130 notifies the processors of an interrupt signal that is a signal input from the I/O devices 141, 142, and 143 via the I/O interface 170.

In addition, the interrupt generation device 3130 includes a designating register 3100 which designates a processor to be notified of the interrupt signal from among the processors (3101, 3102, 3103, or 3104).

The designating register 3100 holds setting of a processor that performs a lowest priority task. Thus, the designating register 3100 previously holds setting of a specific processor assigned with the responsibility for interrupt processing.

The multiprocessor system shown in FIG. 31 improves processing efficiency of the entire system by assigning the responsibility for interrupt processing to the processor designated by the designating register 3100.
[Patent Reference 1] Japanese Unexamined Patent Application Publication No. 2006-216042

### SUMMARY OF THE INVENTION

However, in the conventional interrupt control method, a specific processor is assigned with the responsibility for interrupt processing. When the processor assigned with the responsibility becomes less responsive due to some factor such as temporarily waiting to acquire a shared resource, the responsivity to the interrupt decreases accordingly in terms of the length of time from when the interrupt occurs to when the processor starts processing.

Thus, the present invention is conceived in view of the above circumstances, and it is an object of the present invention to provide a multiprocessor system and a multiprocessor system interrupt control method which improve processing efficiency of the entire system while concurrently securing appropriate interrupt responsivity according to interrupt priority.

To achieve the object described above, the multiprocessor system interrupt control method according to an aspect of the present invention is an interrupt control method for a multiprocessor system which includes: a plurality of processors each including a register; a plurality of I/O devices; and an interrupt generation device, and the interrupt control method includes: setting a mask level value for the register, the mask level value indicating permissibility for an interrupt to be permitted by a corresponding one of the plurality of processors; receiving an interrupt request from one of the plurality of I/O devices, and notifying, to the plurality of processors, the interrupt request and interrupt priority indicating priority for an interrupt by each of the plurality of I/O devices, the receiving and the notifying being performed by the interrupt generation device holding the interrupt priority in a memory unit; and accepting the interrupt request, by one of the plurality of processors that includes the register set to a mask level value lower than a value of the interrupt priority.

In addition, preferably, the multiprocessor system interrupt control method further includes: holding, in a memory, a table indicating a first processor number and a second processor number for the interrupt priority of each of the plurality of I/O devices, the first processor number being the number of processors able to accept the interrupt request, and the second processor number being the number of processors that should be able to accept the interrupt request; changing the second processor number; and changing, when the second processor number is changed, at least one of the mask level values so that the first processor number matches the changed second processor number.

In addition, to achieve the object described above, the multiprocessor system according to another aspect of the present invention is a multiprocessor system which includes: a plurality of processors each including a register; a plurality of I/O devices; and an interrupt generation device, and the multiprocessor system further includes: a setting unit which sets a mask level value for the register, the mask level value indicating permissibility for an interrupt to be permitted by a corresponding one of the plurality of processors; a notifying unit which notifies an interrupt request and interrupt priority to the plurality of processors, the interrupt request being received from one of the plurality of I/O devices by the interrupt generation device holding the interrupt priority in a memory unit, and the interrupt priority indicating priority for an interrupt by each of the plurality of I/O devices; and an acceptance unit which causes one of the plurality of processors to accept the interrupt request, the one of the plurality of processors including the register set to a mask level value lower than a value of the interrupt priority.

In addition, preferably, the multiprocessor system further includes: a holding unit which holds, for the interrupt priority of each of the plurality of I/O devices, a first processor number and a second processor number, the first processor number being the number of processors able to accept the interrupt request, and the second number being the number of processors that should be able to accept the interrupt request; a changing unit which changes the second processor number; and a mask level changing unit which changes, when the second processor number is changed, at least one of the mask level values so that the first processor number matches the changed second processor number.

In addition, the multiprocessor system may further include: a task priority holding unit which holds task priority for a task to be executed by each of the plurality of processors; and a task priority changing unit which changes the task priority according to the task to be executed by each of the plurality of processors, and the changing unit may change the second processor number according to the task priority when the task priority is changed.

In addition, the multiprocessor system may further include: a task priority holding unit which holds an interrupt occurrence frequency for each of the plurality of processors; and an interrupt occurrence frequency changing unit which changes the interrupt occurrence frequency according to the number of interrupts executed by each of the plurality of processors, and the changing unit may change the second processor number according to the interrupt occurrence frequency when the interrupt occurrence frequency is changed.

Note that the present invention can be realized not only as a device but also as an integrated circuit including processing units included in such a device, and can also be realized as: a method including, as steps, the processing units included in the device; a program causing a computer to execute these steps; a recording medium such as a computer readable CD-ROM on which the program is recorded; and information, data, or a signal which represents the program. Furthermore, such program, information, data, and signal may be distributed via a communication network such as the Internet.

According to an implementation of the present invention, it is possible to realize a multiprocessor system and a multiprocessor system interrupt control method which can improve processing efficiency of an entire system while concurrently securing appropriate interrupt responsivity according to interrupt priority.

### FURTHER INFORMATION ABOUT TECHNICAL BACKGROUND TO THIS APPLICATION

The disclosure of Japanese Patent Application No. 2008-097226 filed on Apr. 3, 2008 including specification, drawings and claims is incorporated herein by reference in its entirety.

The disclosure of PCT application No. PCT/JP2009/001285 filed on Mar. 24, 2009, including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a block diagram showing a configuration of a multiprocessor system according to a first embodiment of the present invention;

FIG. 2 is a diagram showing a status of a by-factor priority table according to the first embodiment of the present invention;

FIG. 3 is a diagram showing a relationship between interrupt priority and the number of interrupt permitting processors according to the first embodiment of the present invention;

FIG. 4 is a diagram showing a mask level register value according to the first embodiment of the present invention;

FIG. 5 is a flowchart showing processing during a period from when an I/O device generates an interrupt request to when by-processor interrupt processing starts, according to the first embodiment of the present invention;

FIG. 6 is a flowchart showing the by-processor interrupt processing according to the first embodiment of the present invention;

FIG. 7 is a block diagram showing a configuration of a multiprocessor system according to a second embodiment of the present invention;

FIG. 8 is a diagram showing a relationship between interrupt priority and the number of interrupt permitting processors according to the second embodiment of the present invention;

FIG. 9 is a flowchart showing processing for changing the number of interrupt permitting processors in the multiprocessor system according to the second embodiment of the present invention;

FIG. 10 is a flowchart showing processing for determining whether or not readjustment of the mask level register is necessary in step S93 or S97;

FIG. 11 is a flowchart showing processing for reassigning an interrupt permitting processor in step S94;

FIG. 12 is a flowchart showing processing for changing the mask level register value in step S954 or S956;

FIG. 13 is a diagram showing a status of a by-priority number of processors table and the mask level register of each processor;

FIG. 14 is a diagram showing a status of the by-priority number of processors table and the mask level register of each processor;

FIG. 15 is a diagram showing a status of the by-priority number of processors table and the mask level register of each processor;

FIG. 16 is a block diagram showing a configuration of a multiprocessor system according to a third embodiment of the present invention;

FIG. 17 is a flowchart showing processing for reassigning the interrupt permitting processor in step S94 according to the third embodiment of the present invention;

FIG. 18 is a flowchart showing processing for updating the interrupt permitting processor at the time of task switching in the third embodiment of the present invention;

FIG. 19 is a diagram showing a status of a by-processor task priority table according to the third embodiment of the present invention;

FIG. 20 is a diagram showing a status of the by-processor task priority table according to the third embodiment of the present invention;

FIG. 21 is a diagram showing a status of the by-priority number of processors table, the mask level register of each processor, and the by-processor task priority table according to the third embodiment of the present invention;

FIG. 22 is a diagram showing a status of the by-priority number of processors table, the mask level register of each processor, and the by-processor task priority table according to the third embodiment of the present invention;

FIG. 23 is a block diagram showing a configuration of a multiprocessor system according to a fourth embodiment of the present invention;

FIG. 24 is a flowchart showing processing for reassigning the interrupt permitting processor in step S94 according to the fourth embodiment of the present invention;

FIG. 25 is a flowchart showing by-processor interrupt processing according to the fourth embodiment of the present invention;

FIG. 26 is a diagram showing a status of a by-processor number of interrupts table according to the fourth embodiment of the present invention;

FIG. 27 is a diagram showing a status of the by-processor number of interrupts table according to the fourth embodiment of the present invention;

FIG. 28 is a diagram showing a status of the by-priority number of processors table, the mask level register of each processor, and the by-processor number of interrupts table according to the fourth embodiment of the present invention;

FIG. 29 is a diagram showing a status of the by-priority number of processors table, the mask level register of each processor, and the by-processor number of interrupts table according to the fourth embodiment of the present invention;

FIG. 30 is a diagram showing a status of the by-priority number of processors table, the mask level register of each processor, and the by-processor number of interrupts table according to the fourth embodiment of the present invention; and

FIG. 31 is a block diagram showing a configuration of a multiprocessor system which performs a conventional interrupt control.

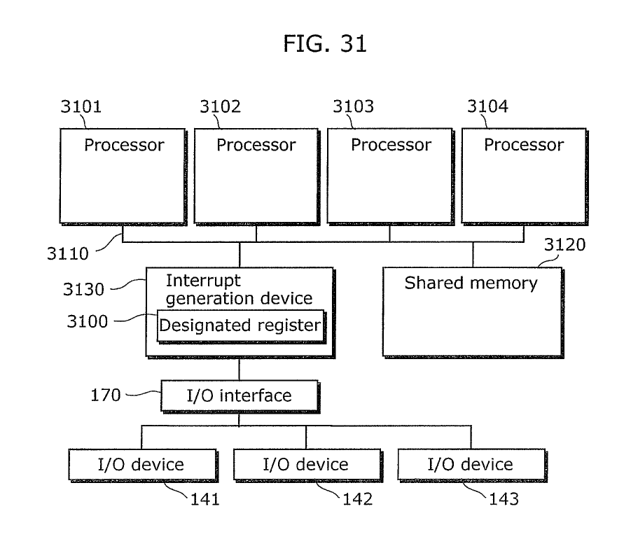

### DESCRIPTION OF THE PREFERRED EMBODIMENTS

Hereinafter, embodiments of the present invention will be described with reference to the drawings.

### First Embodiment

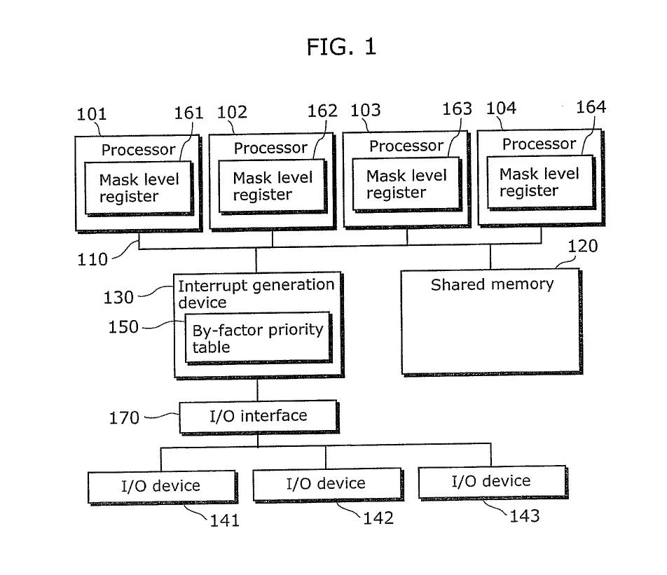

FIG. 1 is a block diagram showing a configuration of a multiprocessor system according to a first embodiment of the present invention.

The multiprocessor system shown in FIG. 1 includes: processors 101, 102, 103, and 104; a shared bus 110; a shared memory 120; an interrupt generation device 130; I/O devices 141, 142, and 143; and an I/O interface 170.

The processors 101, 102, 103, and 104 can communicate with each other via the shared bus 110. In addition, the processors 101, 102, 103, and 104 can access the shared memory 120 via the shared bus 110. In addition, the processors 101, 102, 103, and 104 include mask level registers 161, 162, 163, and 164, respectively.

The interrupt generation device 130 includes a by-factor priority table 150. The by-factor priority table 150 holds interrupt priority previously determined for each of the I/O devices 141, 142, and 143.

In addition, the interrupt generation device 130 is notified of an interrupt request from the I/O device 141, 142, or 143 via the I/O interface 170. The interrupt generation device 130 notifies, via the shared bus 110, all the processors (101, 102, 103, and 104) of: an identification number of the I/O device (141, 142, or 143) that has generated the interrupt request; and the interrupt priority defined for the I/O device (141, 142, or 143) by the by-factor priority table 150.

In addition, the processors 101, 102, 103, and 104 include mask level registers 161, 162, 163, and 164, respectively. Here, the mask level registers 161, 162, 163, and 164 each hold a lowest interrupt priority among interrupt priorities of interrupts to be permitted by each of the processors 101, 102, 103, and 104.

For example, the processor 101 compares, in response to the interrupt request from the interrupt generation device 130, the interrupt priority held by the mask level register 161 and the interrupt priority notified by the interrupt generation device 130. The processor 101 ignores the notice of the interrupt request from the interrupt generation device 130 when the interrupt priority notified by the interrupt generation device 130 is lower than the interrupt priority held by the mask level register 161. When the interrupt priority notified by the interrupt generation device 130 is equal to or higher than the interrupt priority held by the mask level register 161, the processor 101 suspends the processing that it has been performing till then and starts interrupt processing. Note that the processors 102, 103, and 104 are the same as the processor 101, and the description thereof will therefore be omitted.

Thus configured is the multiprocessor system shown in FIG. 1.

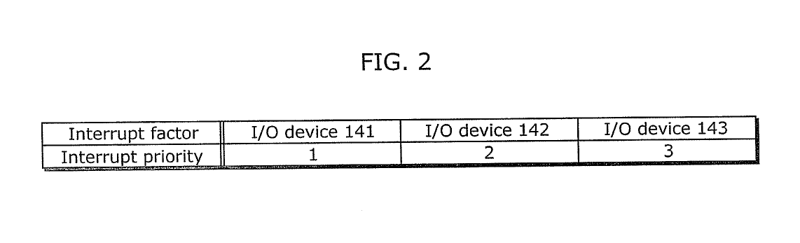

FIG. 2 is a diagram showing a status of the by-factor priority table 150 according to the first embodiment of the present invention. FIG. 2 shows interrupt priority for the I/O devices 141, 142, and 143. FIG. 2 indicates that the interrupt requested from the I/O device 142 should be processed with higher priority than the processing performed by the I/O device 141, and the interrupt requested from the I/O device 143 should be processed with higher priority than the processing performed by the I/O device 142. In other words, as shown in FIG. 2, the by-factor priority table 150 represents an order of interrupt priority between the I/O devices, based on a definition that a larger value of interrupt priority indicates higher interrupt priority.

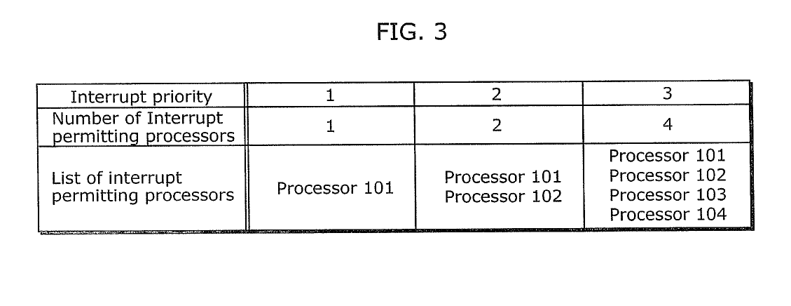

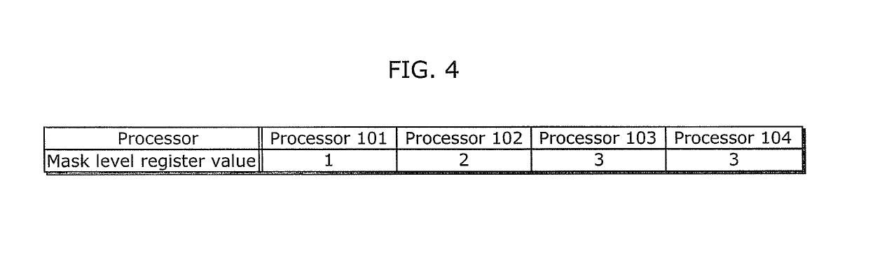

FIG. 3 is a diagram showing a relationship between interrupt priority and the number of interrupt permitting processors according to the first embodiment of the present invention. FIG. 4 is a diagram showing a mask level register value according to the first embodiment of the present invention.

FIG. 3 shows, for the interrupt priority of each of the I/O devices (141, 142, and 143) shown in FIG. 2, a [number of interrupt permitting processors] which indicates a total number of processors permitting an interrupt, and a [list of interrupt permitting processors] which indicates the processor (102, 103, or 104) permitting the interrupt.

At this time, the mask level register value of each of the processors (102, 103, and 104) is defined by a value shown in FIG. 4. Specifically, as shown in FIG. 3, the processor 101 permits an interrupt of interrupt priority 1 or higher, and thus the value of the mask level register 161 shown in FIG. 4 is 1. The processor 102, as shown in FIG. 3, inhibits an interrupt of interrupt priority 1 and permits an interrupt of interrupt priority 2 or higher, and thus the value of the mask level register 162 shown in FIG. 4 is 2. The processor 103 and 104, as shown in FIG. 3, inhibit an interrupt of interrupt priority 2 or lower and permits an interrupt of interrupt priority 3 or higher, and thus the value of the mask level register 163 and 164 shown in FIG. 4 is 3.

Next, an operation of the multiprocessor system according to the first embodiment of the present invention as shown in FIG. 1 will be described with an example.

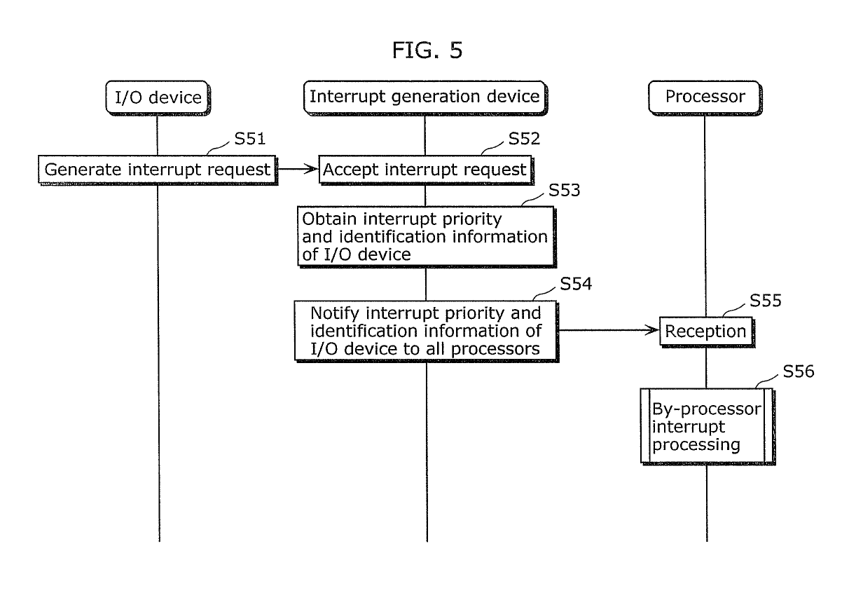

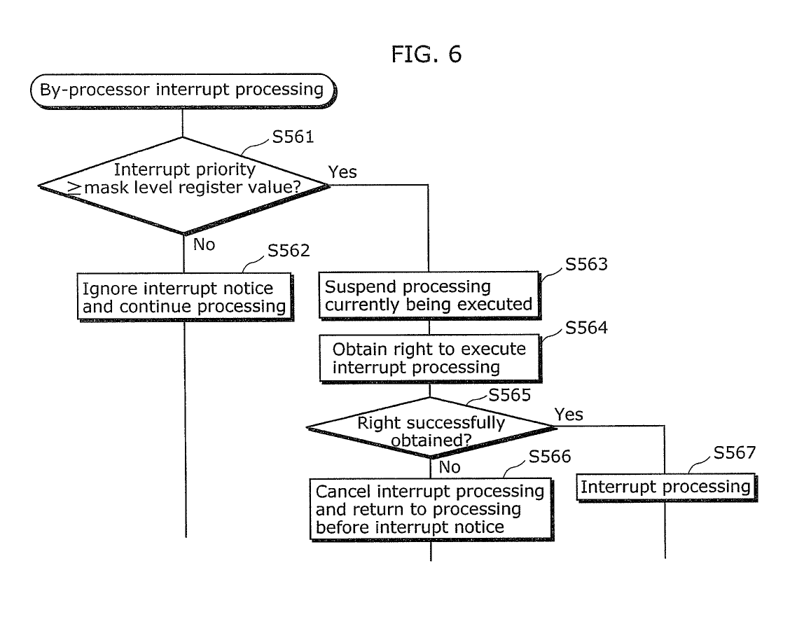

FIG. 5 is a flowchart showing processing during a period from when the I/O device generates an interrupt request to when by-processor interrupt processing starts, according to the first embodiment of the present invention. FIG. 6 is a flowchart showing the by-processor interrupt processing according to the first embodiment of the present invention.

First, for example, when the I/O device 142 generates an interrupt request (step S51), the interrupt request is notified to the interrupt generation device 130 via the I/O interface 170 (step S52).

Next, the interrupt generation device 130 obtains the interrupt priority of the I/O device 142 that has generated the interrupt request, with reference to the by-factor priority table 150 shown in FIG. 2 (step S53). The interrupt generation device 130 notifies, via the shared bus 110, all the processors (101, 102, 103, and 104) of an identification number of the I/O device 142 obtained from the I/O device 142 and the interrupt priority 1 obtained from the by-factor priority table 150 (step S54). Note that the same is applicable to the case where the I/O devices 141 and 143 generate the interrupt request, and the description thereof is therefore omitted.

Next, the processors 101, 102, 103, and 104 receive the notice from the interrupt generation device 130 (step S55), and each of the processors 101, 102, 103, and 104 performs by-processor interrupt processing (step S56).

As described above, the processors 101, 102, 103, and 104 start the by-processor interrupt processing.

Next, as shown in FIG. 6, the processors 101, 102, 103, and 104 compare a value of the interrupt priority of the I/O device 142 notified by the interrupt generation device 130 and the values of the mask level registers 161, 162, 163, and 164 (step S561). When the interrupt priority of the I/O device 142 notified by the interrupt generation device 130 is lower than the value of, for example, the mask level register 164, the processor 104 including the mask level register 164 ignores the interrupt notice from the interrupt generation device 130 and continues processing currently being executed (step S562).

In addition, when the value of the interrupt priority of the I/O device 142 notified by the interrupt generation device 130 is equal to or higher than the value of, for example, the mask level register 162 of the processor 102, the processor 102 accepts the interrupt notice from the interrupt generation device 130 and suspends the processing currently being executed (step S563).

Next, the processor 102 that has accepted the interrupt notice from the interrupt generation device 130 performs exclusive control so as to avoid interrupt processing from being redundantly performed by the processors 101, 103, and 104. Specifically, the processor 102 attempts to obtain a right to execute the interrupt processing corresponding to the identification number of the I/O device 142 notified by the interrupt generation device 130 (step S564). Note that the exclusive control between the processors (101, 102, 103, and 104) can be realized according to a conventional technique such as Mutex.

Next, in the case of a failure in obtaining the right to execute the interrupt processing (No in step S565), the processor 102 cancels the interrupt processing and returns to the processing before the processor 102 received the notice from the interrupt generation device 130 (step S566).

In the case of a success in obtaining the right to execute the interrupt processing (Yes in step S565), the processor 102 executes the interrupt processing corresponding to the identification number of the I/O device 142 notified by the interrupt generation device 130 (step S567).

As described above, the processors 101, 102, 103, and 104 execute the by-processor interrupt processing.

Here, for example, in the case where the I/O device 141 has generated an interrupt request, the interrupt generation device 130 notifies interrupt priority 1 to the processors 101, 102, 103, and 104. Since only the processor 101 has a value of the mask level register equal to or lower than 1, only the processor 101 accepts the notice from the interrupt generation device 130 in accordance with the determination in step S561.

Accordingly, a delay time until the interrupt processing of the I/O device 141 is started is equivalent to a time until the processor 101 starts interrupt processing.

At this time, since the processors 102, 103, and 104 ignore the notice from the interrupt generation device 130 in accordance with the determination in step S561, no cancellation of interrupt processing occurs in any of the processors 101, 102, 103, and 104 in step S566, thus allowing suppressing decrease in processing efficiency.

In addition, for example, in the case where the I/O device 143 has generated an interrupt request, the interrupt generation device 130 notifies interrupt priority 3 to the processors 101, 102, 103, and 104. Since all the processors 101, 102, 103, and 104 have a mask level register 3 or lower, all the processors 101, 102, 103, and 104 have a possibility of accepting the notice from the interrupt generation device 130 in accordance with the determination in step S561.

Therefore, although any of the processors 101, 102, 103, and 104 has a possibility of cancelling the interrupt processing in step S566, the delay time until the interrupt processing of the I/O device 143 is started is shortest among periods of time until the respective processors 101, 102, 103, and 104 start interrupt processing, thus achieving higher response performance than in the case of the I/O device 141 generating the interrupt request.

As described above, according to the interrupt control method used for the multiprocessor system according to the first embodiment, it is possible to suppress decrease in the processing efficiency of the system for an interrupt of lower interrupt priority, and to secure higher response performance for an interrupt of higher interrupt priority. This allows realizing a multiprocessor system and a multiprocessor system interrupt control method which can improve the processing efficiency of the entire system while concurrently securing appropriate interrupt responsivity according to interrupt priority.

### Second Embodiment

A second embodiment will describe a multiprocessor system which can appropriately change an assignment of an interrupt permitting processor for the interrupt priority of each of the I/O devices 141, 142, and 143.

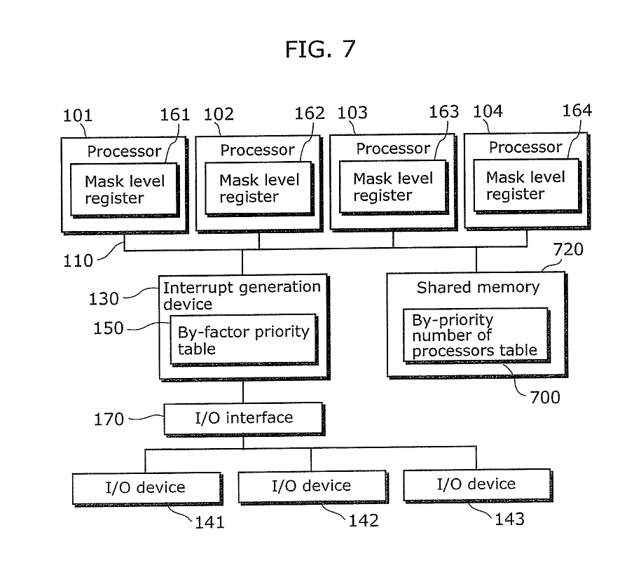

FIG. 7 is a block diagram showing a configuration of a multiprocessor system according to the second embodiment of the present invention. The multiprocessor system shown in FIG. 7 is different from the multiprocessor system according to the first embodiment shown in FIG. 1 in the configuration of the shared memory 720, in that a by-priority number of processors table 700 is added to the shared memory 720 in the present invention. Note that the same element as in FIG. 1 is assigned with the same numerical reference, and the detailed description thereof will be omitted.

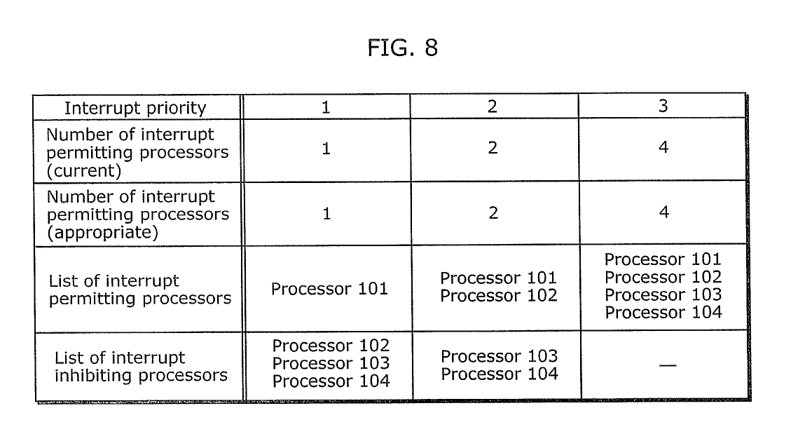

FIG. 8 is a diagram showing a relationship between interrupt priority and the number of interrupt permitting processors according to the second embodiment of the present invention. FIG. 8 shows an example of information that is stored in the by-priority number of processors table 700.

The by-priority number of processors table 700 shown in FIG. 8 is different from that of FIG. 3 in the first embodiment in the manner of indicating the total number of processors permitting an interrupt at the interrupt priority of each I/O device. Specifically, the total number of interrupt permitting processors at the interrupt priority of each I/O device is divided into: a [(current) number of interrupt permitting processors] which indicates, at the interrupt priority of each I/O device, the total number of processors currently permitting an interrupt; and an [(appropriate) number of interrupt permitting processors] which indicates, at the interrupt priority of each I/O device, the total number of processors that should permit an interrupt.

Furthermore, the by-priority number of processors table 700 shown in FIG. 8 additionally includes a [list of interrupt inhibiting processors] which is a list indicating processors inhibiting an interrupt according to the interrupt priority of each I/O device.

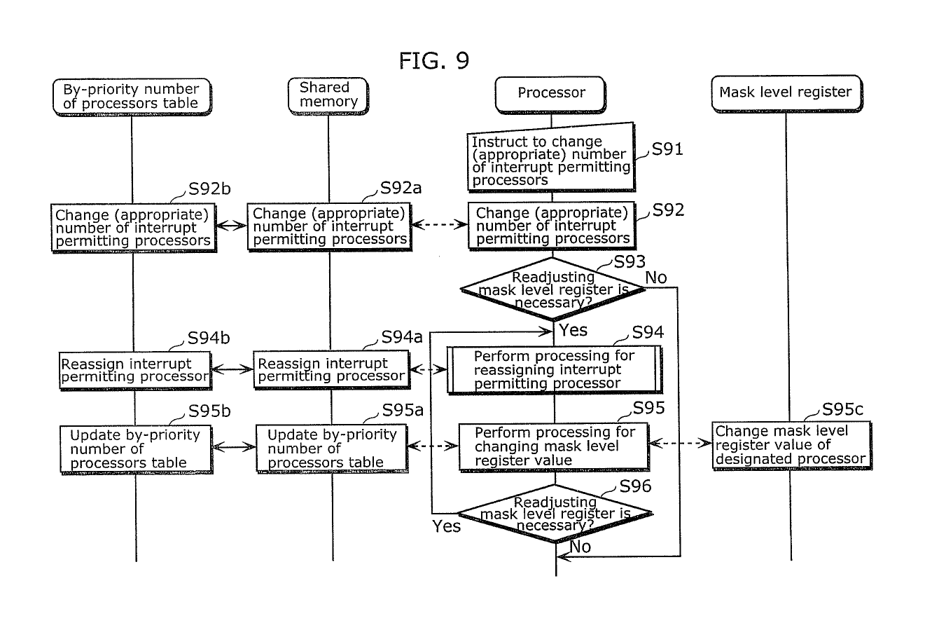

FIG. 9 is a flowchart showing processing for changing the number of interrupt permitting processors in the multiprocessor system according to the second embodiment of the present invention.

First, the processor 104, for example, is instructed to change a value of the [(appropriate) number of interrupt permitting processors] in FIG. 8 (step S91). Here, the processor to be instructed may also be the processor 101, 102, or 103, and the description thereof will be the same in any of the cases and will therefore be omitted.

Next, the processor 104 changes, with reference to the by-priority number of processors table 700, the value of the [(appropriate) number of interrupt permitting processors] in FIG. 8 to a value indicating an arbitrary appropriate number that is instructed (step S92). In other words, the processor 104 changes the value of the [(appropriate) number of interrupt permitting processors] in the by-priority number of processors table 700 stored in the shared memory 720 (step S92a, step S92b).

Next, the processor 104 determines, with reference to the by-priority number of processors table 700, whether or not readjustment of the mask level register is necessary (step S93). Here, when determining that readjustment of the mask level register is not necessary (No in step S93), the processor 104 terminates the processing for changing the number of interrupt permitting processors.

When determining that readjustment of the mask level register is necessary (Yes in step S93), the processor 104 performs processing for reassigning the interrupt permitting processor in the by-priority number of processors table 700 stored in the shared memory 720 (step S94).

Next, the processor 104 changes the mask level register value of the processor (designated processor) that is reassigned as the interrupt permitting processor in step S94 (step S95).

Next, the processor 104 determines, with reference to the by-priority number of processors table 700, whether or not readjustment of the mask level register is necessary (step S96), and terminates the processing for changing the number of interrupt permitting processors when determining that readjustment of the mask level register is not necessary (No in step S96). When determining that readjustment of the mask level register is necessary (Yes in step S96), the processor 104 repeats the processing from step S94 until the processor 104 determines that readjustment of the mask level register is not necessary.

As described above, the multiprocessor system according to the second embodiment performs the processing for changing the number of interrupt permitting processors.

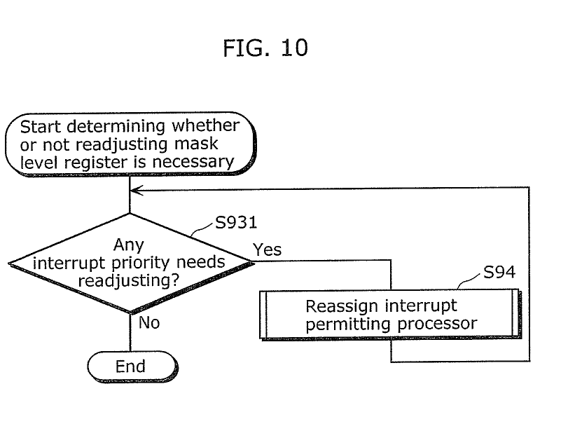

FIG. 10 is a flowchart showing processing for determining whether or not readjustment of the mask level register is necessary in step S93 or S96.

Here, as with FIG. 9, for example, it is assumed that the processor 104 determines whether or not readjustment of the mask level register is necessary and performs readjustment. Note that the cases of the processors 101, 102, and 103 are the same, and the descriptions thereof will therefore be omitted.

First, the processor 104 identifies, with reference to the by-priority number of processors table 700 stored in the shared memory 720, whether or not there is any interrupt priority at which the [(current) number of interrupt permitting processors] and the [(appropriate) number of interrupt permitting processors] do not match. When the [(current) number of interrupt permitting processors] and the [(appropriate) number of interrupt permitting processors] match at all levels of interrupt priority, the processor 104 determines that there is no interrupt priority requiring readjustment (No in step S931), and terminates the determination processing, assuming that the readjustment of the mask level register is not necessary.

Next, when there is any interrupt priority at which the [(current) number of interrupt permitting processors] and the to [(appropriate) number of interrupt permitting processors] do not match (Yes in step S931), the processor 104 performs the processing for reassigning the interrupt permitting processor at the interrupt priority at which the numbers do not match (step S94).

As described above, the multiprocessor system according to the second embodiment determines whether or not readjustment of the mask level register is necessary.

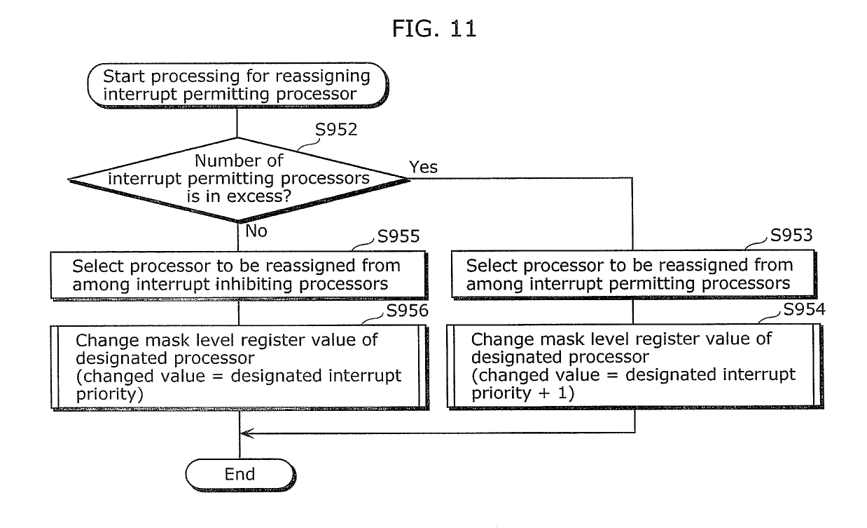

FIG. 11 is a flowchart showing the processing for reassigning the interrupt permitting processor in step S94.

Here, as with FIGS. 9 and 10, it is assumed that the processor 104, for example, performs the processing for reassigning the interrupt permitting processor. Note that the cases of the processors 101, 102, and 103 are the same, and the descriptions thereof will therefore be omitted.

First, the processor 104 refers to the by-priority number of processors table 700 stored in the shared memory 720. The processor 104 compares the values of the [(current) number of interrupt permitting processors] and [(appropriate) number of interrupt permitting processors] that correspond to the interrupt priority at which the [(current) number of interrupt permitting processors] and the [(appropriate) number of interrupt permitting processors] do not match. Then, the processor 104 determines whether or not the (current) number of processors permitting an interrupt is in excess (step S952).

Next, when the [(current) number of interrupt permitting processors] is larger than the [(appropriate) number of interrupt permitting processors], the processor 104 determines that the (current) number of processors permitting an interrupt is in excess (Yes in step S952). Next, the processor 104 selects, as the processor to be reassigned, at least one processor corresponding, in number, to the difference between the [(current) number of interrupt permitting processors] and the [(appropriate) number of interrupt permitting processors] from among the processors included in the [list of interrupt permitting processors] in the by-priority number of processors table 700 (step S953). The processor 104 notifies, via the shared bus 110, each processor selected as the processor to be reassigned to change an interrupt priority value of the corresponding mask level register to, for example, “I/O device's interrupt priority (hereinafter, referred to as the designated interrupt priority)+1” (step S954).

In addition, when in step S952, the [(current) number of interrupt permitting processors] is smaller than the [(appropriate) number of interrupt permitting processors], the processor 104 determines that the (current) number of processors permitting an interrupt is insufficient (No in step S952). Next, the processor 104 selects, as the processor to be reassigned, at least one processor corresponding, in number, to the difference between the [(current) number of interrupt permitting processors] and the [(appropriate) number of interrupt permitting processors] from among the processors included in the [list of interrupt inhibiting processors] in the by-priority number of processors table 700 (step S955). The processor 104 notifies, via the shared bus 110, each processor selected as the processor to be reassigned to change the interrupt priority value of the corresponding mask level register to, for example, the value of the designated interrupt priority (step S956).

As described above, the multiprocessor system according to the second embodiment performs the processing for reassigning the interrupt permitting processor.

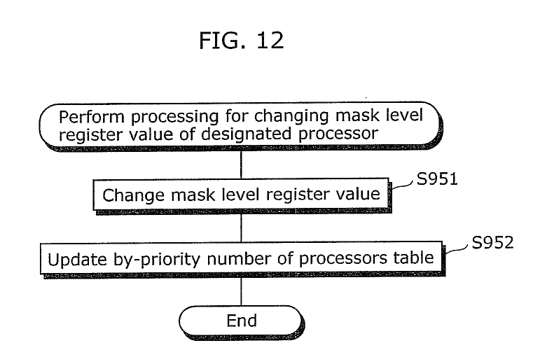

FIG. 12 is a flowchart showing processing for changing the mask level register value in step S954 or S956. Note that the cases of the processors 101, 102, and 103 are the same, and the descriptions thereof will therefore be omitted.

Here, as with FIGS. 9 and 10, it is assumed that the processor 104, for example, executes reassigning of the interrupt permitting processor.

In step S954 or S956, the processor, which has been instructed by the processor 104 to change the interrupt priority value of the mask level register, changes the interrupt priority value of the corresponding mask level register to a designated value (step S951).

Next, when the [list of interrupt permitting processors] includes, at a designated interrupt priority (I/O device interrupt priority) that is lower than the interrupt priority after the change of the interrupt priority value of the mask level register, a processor corresponding to the mask level register, the processor 104 deletes the processor from the [list of interrupt permitting processors]. Then, the processor 104 updates the by-priority number of processors table 700 by adding the deleted processor to the “list of interrupt inhibiting processors” and subtracting 1 from the [(current) number of interrupt permitting processors] (step S952).

In addition, when the [list of interrupt inhibiting processors] includes, at a designated interrupt priority (I/O device interrupt priority) that is equal to or higher than the interrupt priority after the change of the interrupt priority value of the mask level register, a processor corresponding to the mask level register, the processor 104 deletes the processor from the [list of interrupt inhibiting processors]. Then, the processor 104 updates the by-priority number of processors table 700 by adding the deleted processor to the [list of interrupt permitting processors] and adding 1 to the [(current) number of interrupt permitting processors] (step S952).

As described above, the multiprocessor system according to the second embodiment performs the processing for changing the mask level register value.

Next, an operation of the multiprocessor system according to the second embodiment of the present invention as shown in FIG. 7 will be described with an example.

Here, it is assumed that the by-priority number of processors table 700 is in a state as shown in FIG. 8. The following will describe an example of an operation performed, at this time, for changing the number of processors that should permit an interrupt from 2 to 1 at I/O device interrupt priority (designated interrupt priority) 2.

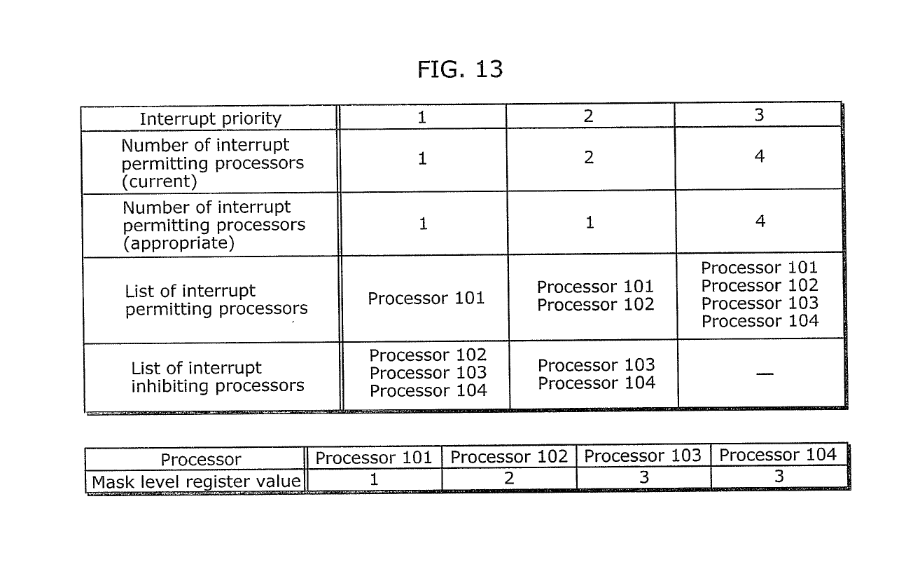

FIGS. 13, 14, and 15 are diagrams each showing a status of the by-priority number of processors table 700 and the mask level register in each processor.

First, the processor 104 changes, from 2 to 1, the [(appropriate) number of interrupt permitting processors] corresponding to the designated interrupt priority 2, with reference to the by-priority number of processors table 700 (step S92). Here, FIG. 13 shows a status of the by-priority number of processors table 700 and the mask level registers 161, 162, 163, and 164 of the processors 101, 102, 103, and 104 immediately after performance of the processing in step S92.

Next, the processor 104 determines, with reference to the by-priority number of processors table 700, whether or not readjustment of the mask level register is necessary (step S93), and performs the processing for reassigning the interrupt permitting processor (step S94).

Specifically, in step S93, the processor 104 identifies, with reference to the by-priority number of processors table 700, whether or not there is any designated interrupt priority at which the [(current) number of interrupt permitting processors] and the [(appropriate) number of interrupt permitting processors] do not match. Since the [(current) number of interrupt permitting processors] and the [(appropriate) number of interrupt permitting processors] do not match at the designated interrupt priority 2 (Yes in step S931), the processor 104 performs the processing for reassigning the interrupt permitting processor at the designated interrupt priority 2 (step S94).

In step S94, the processor 104 compares, with reference to the by-priority number of processors table 700, the values of the [(current) number of interrupt permitting processors] and the [(appropriate) number of interrupt permitting processors] at the designated interrupt priority 2. Then, the processor 104 determines whether or not the (current) number of the processors permitting an interrupt is in excess (step S952).

Since, at the designated interrupt priority 2, the [(current) number of interrupt permitting processors] is larger than the [(appropriate) number of interrupt permitting processors] by 1, the processor 104 determines that the number of processors permitting an interrupt is in excess (Yes in step S952). Next, the processor 104 selects one of the processors included in the [list of interrupt permitting processors] as the processor to be reassigned (step S953). The processor 104 notifies via the shared bus 110, a processor 101, for example, which is selected as the processor to be reassigned to change the value of the mask level register 161 from 1 to 3 (the designated interrupt priority 2+1) (step S954). Note that here the processor 101 is assumed as being selected as the processor whose mask level register is to be changed, but the present embodiment is not limited to this.

Next, in step S94, the processor 104 performs the processing for changing the mask level register value on the processor that is to be reassigned as the interrupt permitting processor (step S95).

Specifically, in step S95, the processor 101, which has been instructed by the processor 104 to change the interrupt priority value of the mask level register 161, changes the value of the mask level register 161 from 1 to 3 (step S951). Next, the processor 104 deletes the processor 101 from the [list of interrupt permitting processors] at the designated interrupt priority 1 and 2. Then, the processor 104 updates the by-priority number of processors table 700 by adding the processor 101 to the [list of interrupt inhibiting processors] and subtracting 1 from the [(current) number of interrupt permitting processors] (step S952). At this time, since the processor 101 is not included in the [list of interrupt inhibiting processors] at the designated interrupt priority 3, the processor 104 does not change the [(current) number of interrupt permitting processors] at the designated interrupt priority 3 .

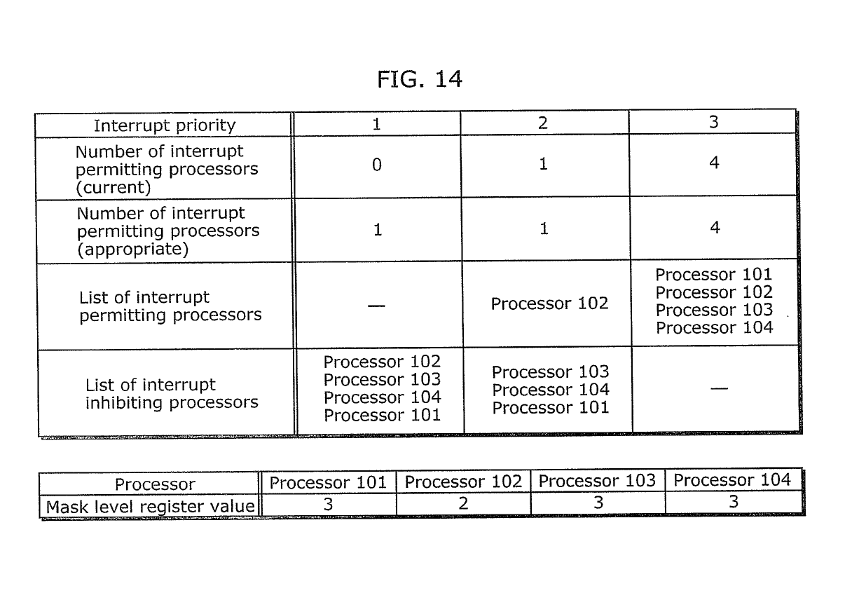

Here, FIG. 14 shows a status of the by-priority number of processors table 700 and the mask level registers 161, 162, 163, and 164 of the processors 101, 102, 103, and 104 immediately after performance of the processing in step S952.

Next, the processor 104 determines, with reference to the by-priority number of processors table 700, whether or not further readjustment of the mask level register is necessary (step S96), and re-performs the processing for reassigning the interrupt permitting processor (step S94).

Specifically, in step S96, the processor 104 identifies, with reference to the by-priority number of processors table 700, whether or not there is any designated interrupt priority at which the [(current) number of interrupt permitting processors] and the [(appropriate) number of interrupt permitting processors] do not match. Since the [(current) number of interrupt permitting processors] and the [(appropriate) number of interrupt permitting processors] do not match at the designated interrupt priority 1 (Yes in step S931), the processor 104 performs the processing for reassigning the interrupt permitting processor at the designated interrupt priority 1 (step S94).

In step S94, the processor 104 compares, with reference to the by-priority number of processors table 700, the values of the [(current) number of interrupt permitting processors] and the [(appropriate) number of interrupt permitting processors] at the designated interrupt priority 1. Then, the processor 104 determines whether or not the (current) number of the processors permitting an interrupt is in excess (step S952).

Since, at the designated interrupt priority 1, the [(current) number of interrupt permitting processors] is smaller than the [(appropriate) number of interrupt permitting processors] by 1, the processor 104 determines that the number of processors permitting an interrupt is insufficient (No in step S952). Next, the processor 104 selects one of the processors included in the [list of interrupt inhibiting processors] as the processor to be reassigned (step S955). The processor 104 notifies, via the shared bus 110, a processor 102, for example, which is selected as the processor to be reassigned to change the value of the mask level register 162 from 2 to 1 (the designated interrupt priority 1 ) (step S956). Note that here the processor 102 is assumed as being selected as the processor whose mask level register is to be changed, but the present embodiment is not limited to this.

Next, in step S94, the processor 104 performs the processing for changing the mask level resister value on the processor reassigned as the interrupt permitting processor (step S95).

Specifically, in step S95, the processor 102, which has been instructed by the processor 104 to change the interrupt priority value of the mask level register 162, changes the value of the mask level register 162 from 2 to 1 (step S951). Next, the processor 104 deletes the processor 102 from the [list of interrupt inhibiting processors] at the designated interrupt priority 1. Then, the processor 104 updates the by-priority number of processors table 700 by adding the processor 102 to the [list of interrupt permitting processors] and adding 1 to the [(current) number of interrupt permitting processors] (step S952). At this time, since the processor 102 is not included in the [list of interrupt inhibiting processors] at the designated interrupt priority 2 and 3, the processor 104 does not change the [(current) number of interrupt permitting processors] at the designated interrupt priority 2 and 3.

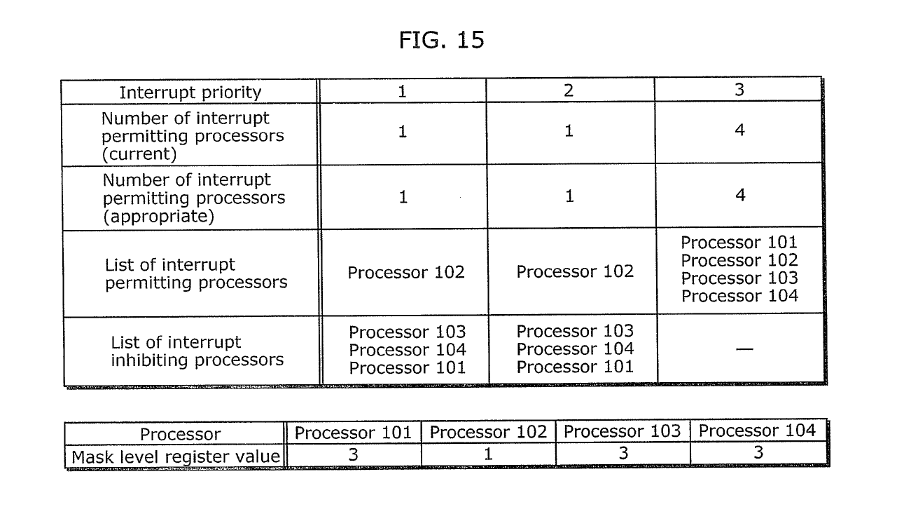

Here, FIG. 15 shows a status of the by-priority number of processors table 700 and the mask level registers 161, 162, 163, and 164 of the processors 101, 102, 103, and 104 immediately after performance of the processing in step S952.

Next, the processor 104 determines, with reference to the by-priority number of processors table 700, whether or not further readjustment of the mask level register is necessary (step S96). As shown in FIG. 15, since the [(current) number of interrupt permitting processors] and the [(appropriate) number of interrupt permitting processors] match at all the levels of the designated interrupt priority, the processor 104 determines that readjustment of the mask level register is not necessary (No in step S96) and terminates the processing for changing the number of interrupt permitting processors.

As described above, the multiprocessor system according to the second embodiment performs processing for changing the number of interrupt permitting processors by executing readjustment of the mask level register in each processor so as to match, at all the levels of the designated interrupt priority, the [(current) number of interrupt permitting processors] that is the total number of processors currently permitting an interrupt with the [(appropriate) number of interrupt permitting processors] that is the total number of processors to that should permit an interrupt.

As described above, according to the multiprocessor system interrupt control method according to the second embodiment, it is possible to arbitrarily change the assignment of the interrupt permitting processor, in addition to the multiprocessor system interrupt control method according to the first embodiment. This allows realizing a multiprocessor system and a multiprocessor system interrupt control system which can improve processing efficiency of the entire system while concurrently securing appropriate interrupt responsivity according to interrupt priority.

### Third Embodiment

A third embodiment will describe a multiprocessor system interrupt control method intended to optimize the entire system by further providing, in the interrupt method for the multiprocessor system according to the second embodiment, a selection criterion for selecting the interrupt permitting processor from among all the processors so as to optimize the entire system.

Particularly, the third embodiment will describe the multiprocessor system interrupt control method for efficiently executing a task of higher task priority with reference to, as a selection criterion, the priority of the task executed by each processor in an operating system (OS) which controls a plurality of tasks on the multiprocessor system.

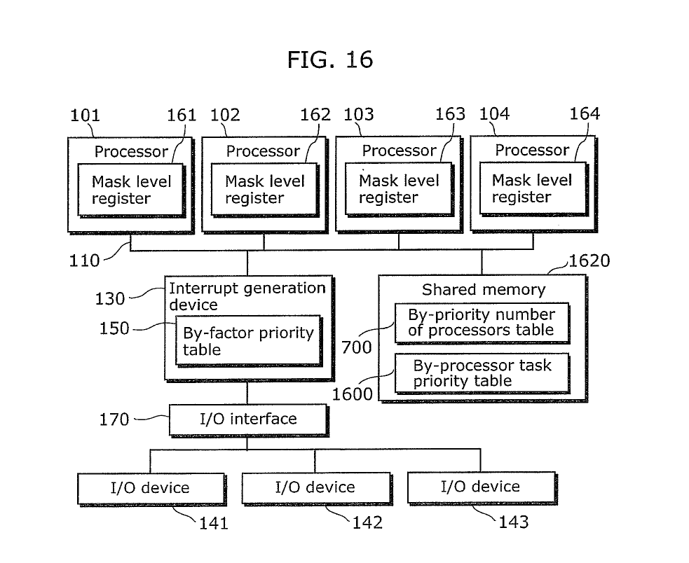

FIG. 16 is a block diagram showing a configuration of the multiprocessor system according to the third embodiment of the present invention. The multiprocessor system shown in FIG. 16 is different from the multiprocessor system according to the second embodiment as shown in FIG. 7 in the configuration of the shared memory 1620, in that a by-processor task priority table 1600 is further added to the shared memory 1620. Note that the same element as in FIGS. 1 and 7 is assigned with the same numerical reference, and the detailed description thereof will be omitted. In addition, as with the multiprocessor system according to the second embodiment, the multiprocessor system according to the third embodiment performs the processing for changing the number of interrupt permitting processors as shown in FIG. 9.

The by-processor task priority table 1600 holds, for each of the processors (101, 102, 103, and 104), task priority of the task currently being performed by the processor (101, 102, 103, and 104).

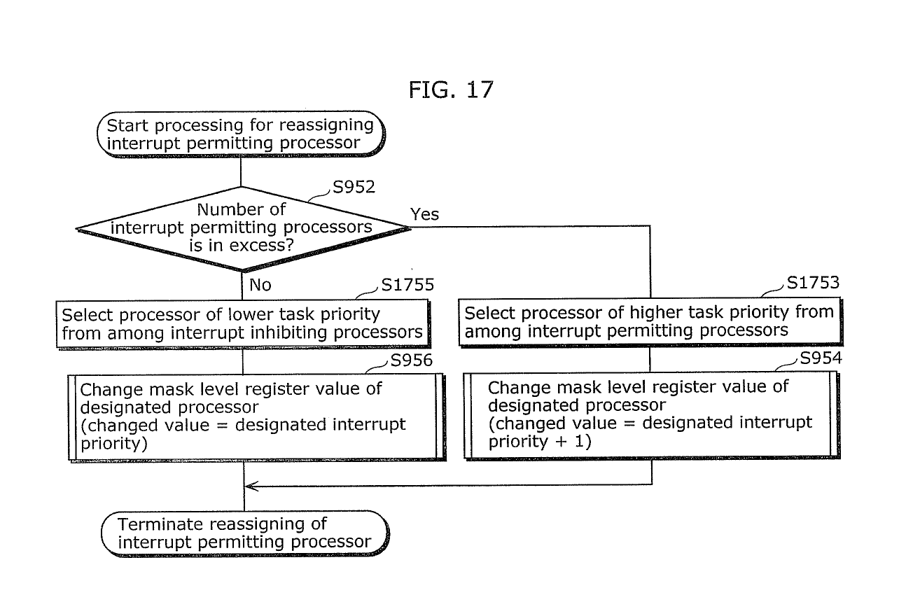

FIG. 17 is a flowchart showing the processing for reassigning the interrupt permitting processor in step S94 according to the third embodiment. Note that the same element as in FIG. 11 in the second embodiment is assigned with the same numerical reference, and the detailed description thereof will be omitted.

FIG. 17 is different from FIG. 11 in the second embodiment in that: the step (step S953) of selecting, from among the interrupt permitting processors, the processor to be reassigned as the interrupt inhibiting processor is extended to a step (step S1753) of preferentially selecting the processor currently executing a task of higher priority. In addition, another difference from FIG. 11 in the second embodiment is that: the step (step S955) of selecting, from among the interrupt inhibiting processors, the processor to be reassigned as the interrupt permitting processor is extended to a step (step S1755) of preferentially selecting the processor currently executing a task of lower priority.

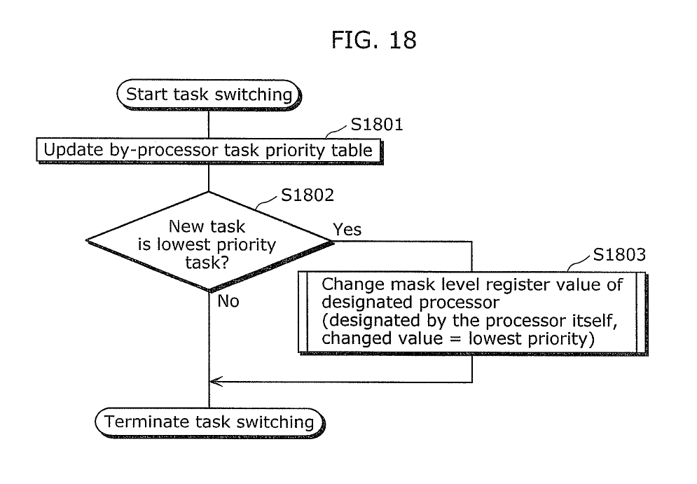

FIG. 18 is a flowchart showing processing for updating the interrupt permitting processor at the time of task switching in the third embodiment.

When performing task switching, the processor 101, 102, 103, or 104 changes, with reference to the by-processor task priority table 1600 held by the shared memory 720, the task priority corresponding to the processor 101, 102, 103, or 104 to the task priority of the task that is to be newly executed by the processor 101, 102, 103, or 104 (step S1801).

Next, when the task to be newly executed by the processor 101, 102, 103, or 104 (hereinafter, referred to as a designated processor) is of lowest priority such as an idle status (Yes in step S1802), the processor 101, 102, 103, or 104 changes the interrupt priority at the mask level register of the designated processor to the lowest interrupt priority (step S1803), and performs the processing for changing the mask level register value of the designated processor. Note that the processing for changing the mask level register value of the designated processor in S1803 is the same as FIG. 12 in the second embodiment, and the description thereof will therefore be omitted.

As described above, the multiprocessor system according to the third embodiment performs the processing for updating the interrupt permitting processor at the time of task switching. With this, after this processing, the processor executing the task of lowest priority is determined as the interrupt permitting processor, and the processor executing the task of higher priority is determined instead as the interrupt inhibiting processor, thus enabling efficient performance of the task of higher priority.

Next, an operation of the multiprocessor system according to the third embodiment of the present invention as shown in FIG. 16 will be described in detail with an example.

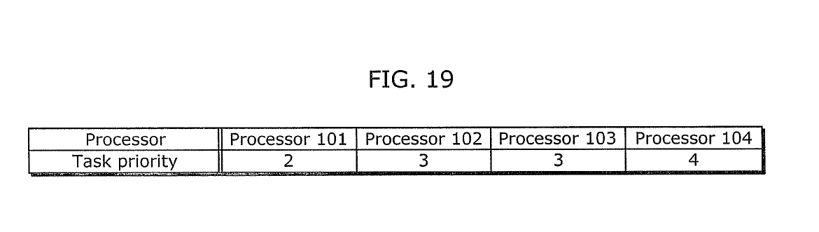

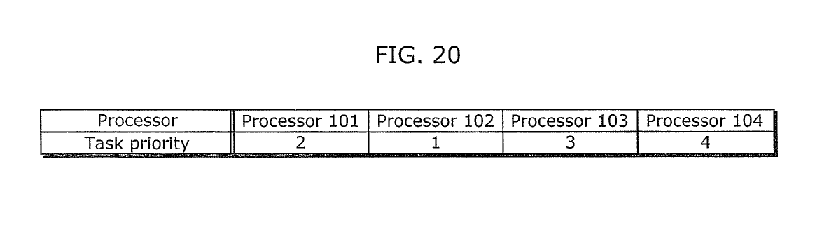

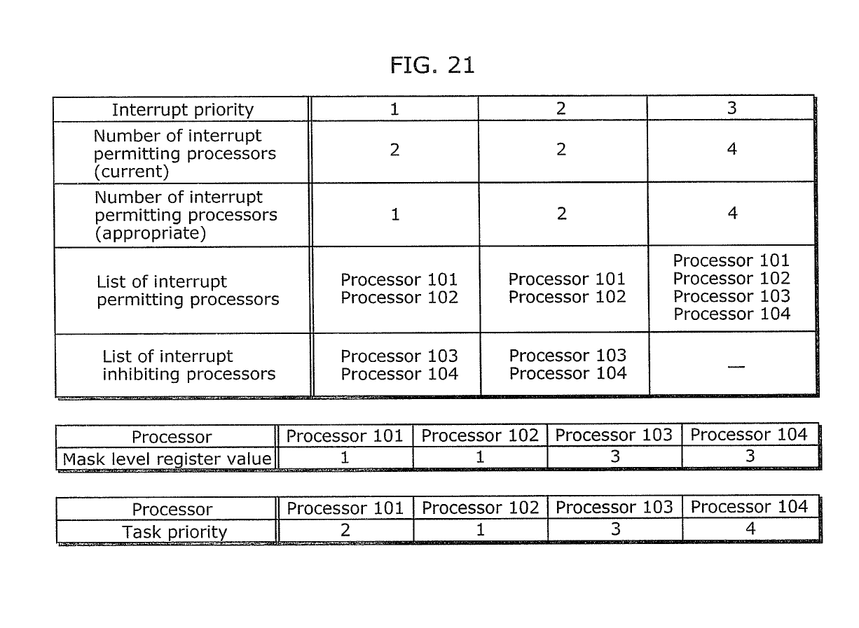

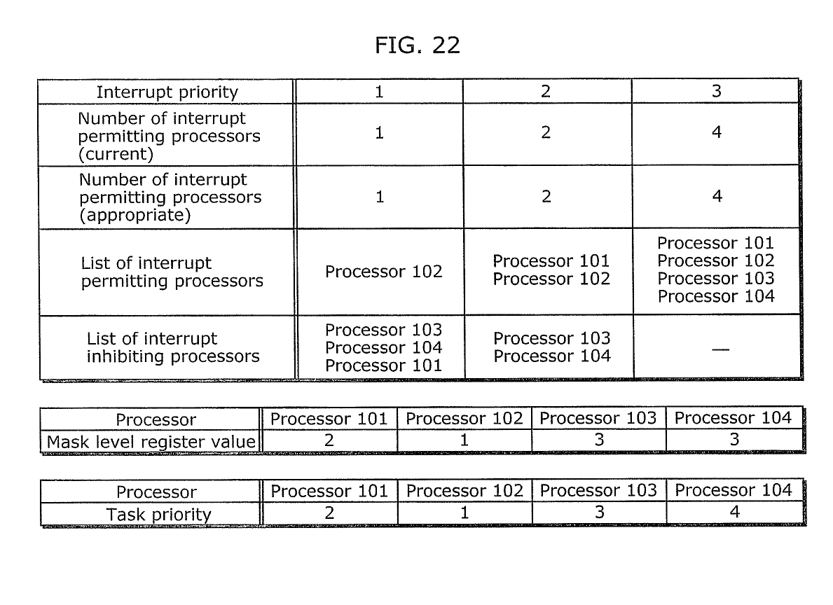

FIGS. 19 and 20 are diagrams showing a status of the by-processor task priority table 1600. FIGS. 21 and 22 are diagrams showing a status of the by-priority number of processors table 700, the mask level register of each processor, and the by-processor task priority table 1600.

Here, it is assumed that the by-priority number of processors table 700 is in a state as shown in FIG. 8, and that the by-processor task priority table 1600 is in a state as shown in FIG. 19. Here described is an example where task switching occurs in the processor 102, and the task priority of the processor 102 is switched to the lowest task priority (priority 1 ).

First, the processor 102 changes the task priority corresponding to the processor 102 from 3 to the lowest priority 1 , with reference to the by-processor task priority table 1600 (step S1801). Here, FIG. 20 shows the status of the by-processor task priority table 1600 immediately after performance of the processing in step S1801.

Next, since the priority of the task to be newly executed by the processor 102 is the lowest priority, that is, the task currently performed in the processor 102 is to be switched to the lowest priority task, the processor 102 changes the value of the mask level register 162 corresponding to the processor 102 to the lowest interrupt priority 1. Then, the processor 102 performs the processing for changing the mask level register value of the designated processor (step S1802).

In S1802, first, the processor 102 changes the value of the corresponding mask level register 162 from 2 to 1 (step S951). Next, the processor 102 deletes the processor 102 from the [list of interrupt inhibiting processors] at the designated interrupt priority 1. Then, the processor 102 adds the processor 102 to the [list of interrupt permitting processors], and also adds 1 to the [(current) number of interrupt permitting processors] (step S952). Here, FIG. 21 shows a status of the by-priority number of processors table 700, the mask level registers 161, 162, 163, and 164, and the by-processor task priority table 1600 immediately after performance of the processing in step S952.

Next, as shown in FIG. 9, the processor 102 determines, with reference to the by-priority number of processors table 700, whether or not readjustment of the mask level register is necessary (step S93), and performs the processing for reassigning the interrupt permitting processor (step S94).

Specifically, in step S93, since, with reference to the by-priority number of processors table 700, the [(current) number of interrupt permitting processors] and the [(appropriate) number of interrupt permitting processors] do not match at the designated interrupt priority 1 (Yes in step S931), the processor 102 performs the processing for reassigning the interrupt permitting processor at the designated interrupt priority 1 (step S94).

In step S94, with reference to the by-priority number of processors table, the processor 102 compares the values of the [(current) number of interrupt permitting processors] and the [(appropriate) number of interrupt permitting processors] at the designated interrupt priority 1. Then, the processor 102 determines whether or not the (current) number of the processors permitting an interrupt is in excess (step S952).

Since, at the designated interrupt priority 1, the [(current) number of interrupt permitting processors] is larger than the [(appropriate) number of interrupt permitting processors] by 1, the processor 102 determines that the number of processors permitting an interrupt is in excess (Yes in step S952). Next, the processor 102 selects the processor 101 currently performing a task of highest task priority from among the processors included in the [list of interrupt permitting processors] (step S1753), and notifies the processor 101 to change the value of the mask level register 161 from 1 to 2 (step S954).

Next, in step S94, the processor 102 performs the processing for changing the mask level register value on the processor that is to be reassigned as the interrupt permitting processor (step S95).

Specifically, in step S95, the processor 101, which has been instructed by the processor 102 to change the interrupt priority value of the mask level register 161, changes the value of the mask level register 161 from 1 to 2 (step S951). Next, the processor 102 deletes the processor 101 from the [list of interrupt permitting processors] at the designated interrupt priority 1. Then, the processor 102 adds the processor 101 to the [list of interrupt inhibiting processors], and also subtracts 1 from the [(current) number of interrupt permitting processors] (step S952). Here, FIG. 22 shows a status of the by-priority number of processors table 700 and the mask level registers 161, 162, 163, and 164 of the processors 101, 102, 103, and 104 immediately after performance of the processing in step S952.

Next, the processor 102 determines, with reference to the by-priority number of processors table 700, whether or not further readjustment of the mask level register is necessary (step S96). As shown in FIG. 22, since the [(current) number of interrupt permitting processors] and the [(appropriate) number of interrupt permitting processors] match at all the levels of interrupt priority, the processor 102 determines that readjustment of the mask level register is not necessary (No in step S96) and terminates the processing for changing the number of interrupt permitting processors.

At this time, the value of the mask level register 161 of the processor 101 is set to a value higher than the value of the mask level register 162 of the processor 102, thus suppressing an occurrence of an interrupt in the processor currently executing the task of higher task priority.

As described above, the multiprocessor system according to the third embodiment performs the processing for changing the number of interrupt permitting processors.

As described above, according to the third embodiment, it is possible to realize a multiprocessor system interrupt control method for efficiently executing a task of higher task priority.

Note that in the third embodiment the processing for reassigning the interrupt permitting processor is performed at the time of switching to the lowest priority task, but such processing may also be performed with other arbitrary timing. For example, the processing may be performed when switching to the task of arbitrary priority, or may be periodically performed using a timer handler or the like.

### Fourth Embodiment

A fourth embodiment will describe a multiprocessor system interrupt control method intended to optimize the entire system, as with the third embodiment, by further providing, in the multiprocessor system interrupt method according to the second embodiment, a selection criterion for selecting the interrupt permitting processor from among all the processors.

Particularly, the fourth embodiment will describe a multiprocessor system interrupt control method for distributing interrupt processing by avoiding a concentration of interrupts in a specific processor with reference to an interrupt occurrence frequency in each processor as a selection criterion.

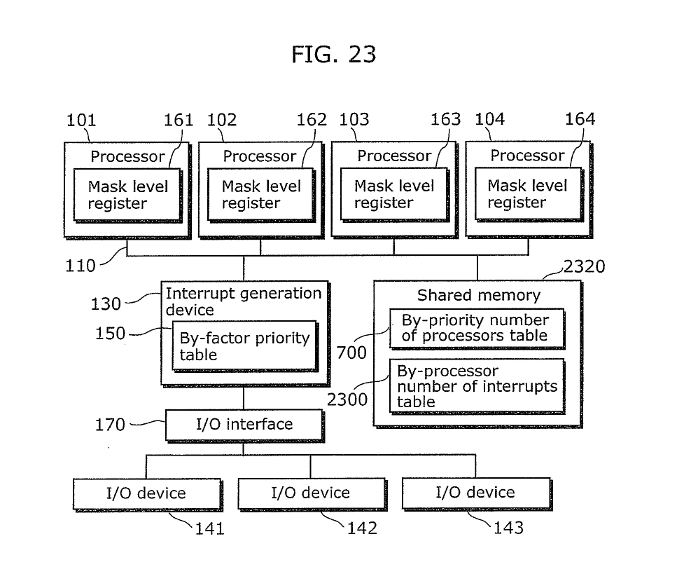

FIG. 23 is a block diagram showing a configuration of the multiprocessor system according to the fourth embodiment of the present invention. The multiprocessor system shown in FIG. 23 is different from the multiprocessor system according to the second embodiment as shown in FIG. 7 in the configuration of the shared memory 2320, in that a by-processor number of interrupts table 2300 is further added to the shared memory 2320 in the present embodiment. Note that the same element as in FIGS. 1 and 7 is assigned with the same numerical reference, and the detailed description thereof will be omitted. In addition, as with the multiprocessor system according to the second embodiment, the multiprocessor system according to the fourth embodiment performs the processing for changing the number of interrupt permitting processors as shown in FIG. 9.

The by-processor number of interrupts table 2300 holds, for each of the processors (101, 102, 103, and 104), a frequency of interrupt processing performed by the processors (101, 102, 103, and 104).

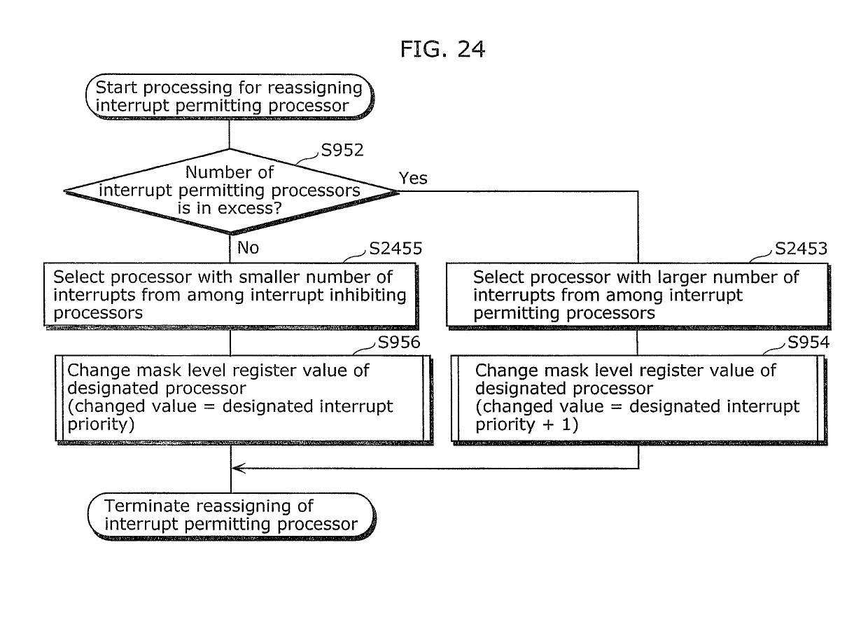

FIG. 24 is a flowchart showing the processing for reassigning the interrupt permitting processor in step S94 according to the fourth embodiment of the present invention. Note that the same element as in FIG. 11 in the second embodiment is assigned with the same numerical reference, and the detailed description thereof will be omitted.

FIG. 24 is different from FIG. 11 in the second embodiment in that: the step (S953) of selecting, from among the interrupt permitting processors, the processor to be reassigned as the interrupt inhibiting processor is extended to a step (52453) of preferentially selecting the processor with a larger number of interrupt occurrences. In addition, another difference from FIG. 11 in the second embodiment is that: the step (S955) of selecting, from among the interrupt inhibiting processors, the processor to be reassigned as the interrupt permitting processor is extended to a step (S2455) of selecting the processor with a smaller number of interrupt occurrences.

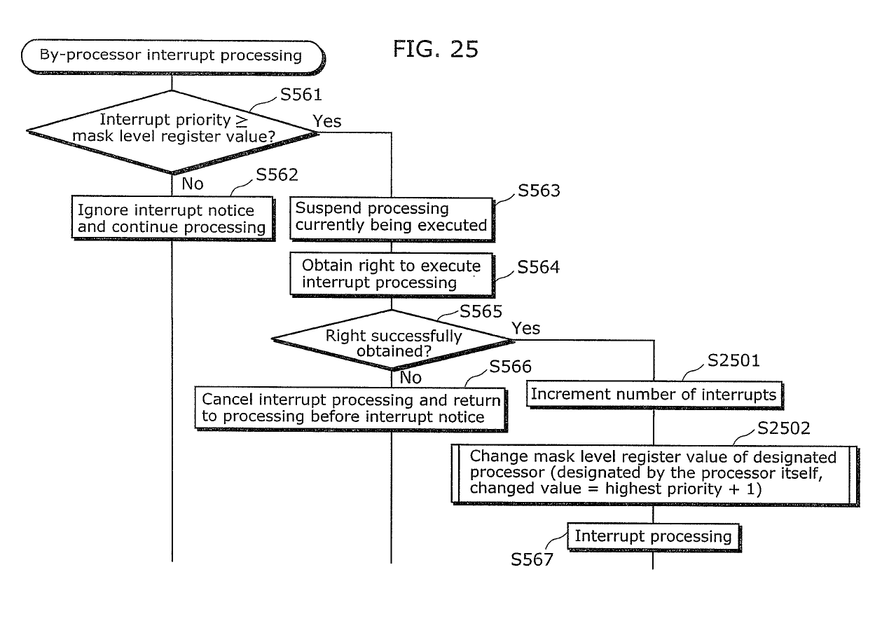

FIG. 25 is a flowchart showing the by-processor interrupt processing according to the fourth embodiment. Note that the same processing as in FIG. 6 in the first embodiment is assigned with the same numerical reference, and the detailed description thereof will be omitted.

Compared to FIG. 6 in the first embodiment, FIG. 25 additionally includes, immediately after obtaining an interrupt processing right (Yes in step S565), a step (S2501) of incrementing, in each processor, the number of interrupts that corresponds to each processor itself with reference to the by-processor number of interrupts table 2300. Furthermore, another difference is that FIG. 25 additionally includes a step (S2502) of performing the processing for changing the value of the mask level register of the designated processor by changing the interrupt priority at the mask level register of the designated processor to, for example, the interrupt priority of the highest priority+1. Note that the processing for changing the mask level register value of the designated processor in step S2502 is the same as FIG. 12 in the second embodiment, and the description thereof will therefore be omitted.

As described above, the multiprocessor system according to the fourth embodiment performs by-processor interrupt processing.

Next, an operation of the multiprocessor system according to the fourth embodiment of the present invention as shown in FIG. 23 will be described in detail with an example.

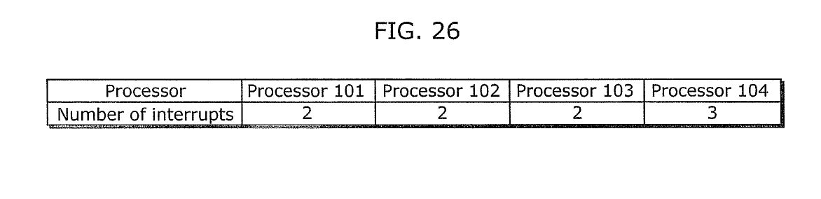

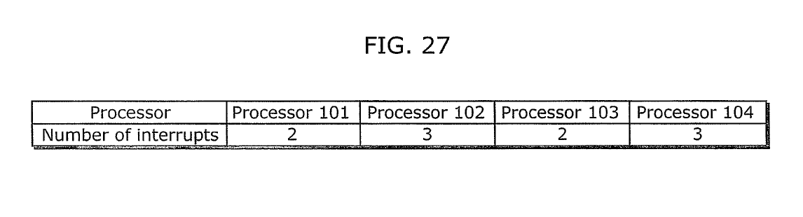

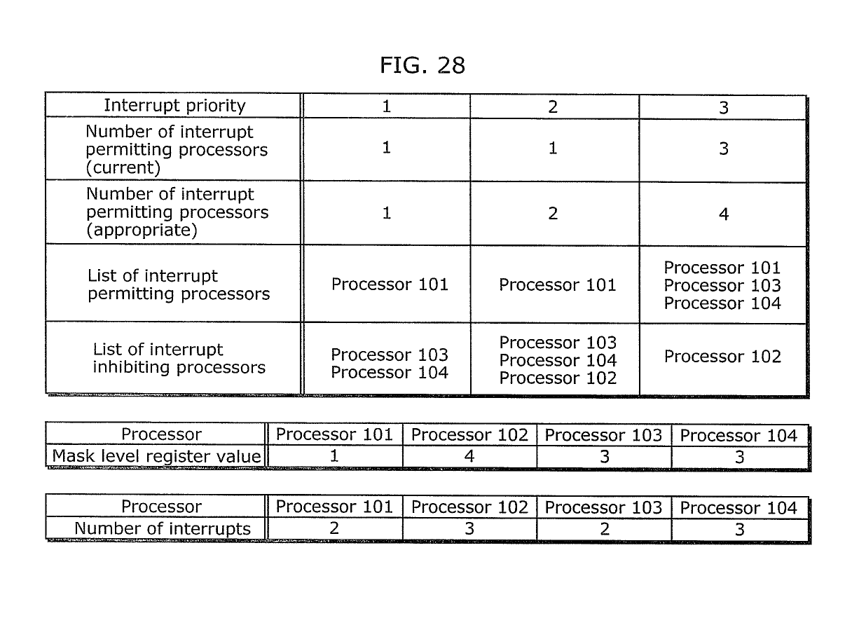

FIGS. 26 and 27 are diagrams showing a status of the by-processor number of interrupts table 2300. FIGS. 28, 29, and 30 are diagrams each showing a status of the by-priority number of processors table 700, the mask level register of each processor, and the by-processor number of interrupts table 2300.

Here, it is assumed that the by-priority number of processors table 700 is in a state as shown in FIG. 8, and that the by-processor number of interrupts table 2300 is in a state as shown in FIG. 26. Here, an operation of the processor 102 executing interrupt processing in the case where the I/O device 142 has generated an interrupt request will be described with an example.

After obtaining the right to execute interrupt processing (Yes in step S565), the processor 102 increments the number of interrupts that corresponds to the processor 102, with reference to the by-processor number of interrupts table 2300 (step S2501). That is, the processor 102 changes the number of interrupts that corresponds to the processor 102 from 2 to 3. Here, FIG. 27 shows a status of the by-processor number of interrupts table 2300 immediately after performance of the processing in step S2501.

Next, the processor 102 designates the processor 102 and interrupt priority 4, and starts processing for changing the value of the mask level register 162 (step S2502).

In S2502, first, the processor 102 changes, from 2 to 4, the value of the mask level register 162 corresponding to the processor 102 itself (step S951). Next, the processor 102 deletes the processor 102 from the [list of interrupt permitting processors] at the designated interrupt priority 2 and 3. Then, the processor 102 adds the processor 102 to the [list of interrupt inhibiting processors], and also subtracts 1 from the [(current) number of interrupt permitting processors] (step S952). Here, FIG. 28 shows a status of the by-priority number of processors table 700, the mask level registers 161, 162, 163, and 164 of the processors 101, 102, 103, and 104, and the by-processor number of interrupts table 2300 immediately after performance of the processing in step S952.

Next, the processor 102 determines, with reference to the by-priority number of processors table 700, whether or not readjustment of the mask level register is necessary (step S93), and performs the processing for reassigning the interrupt permitting processor (step S94).

Specifically, in step S93, since, with reference to the by-priority number of processors table 700, the [(current) number of interrupt permitting processors] and the [(appropriate) number of interrupt permitting processors] do not match at the designated interrupt priority 2 (Yes in step S931), the processor 102 performs the processing for reassigning the interrupt permitting processor at the designated interrupt priority 2 (step S94).

In step S94, the processor 102 compares, with reference to the by-priority number of processors table 700, the values of the [(current) number of interrupt permitting processors] and the [(appropriate) number of interrupt permitting processors] at the designated interrupt priority 2. Then, the processor 102 determines whether or not the (current) number of interrupt permitting processors is in excess (step S952).

Since, at the designated interrupt priority 2, the [(current) number of interrupt permitting processors] is smaller than the [(appropriate) number of interrupt permitting processors] by 1, the processor 102 determines that the number of interrupt permitting processors is insufficient (No in step S952). Next, the processor 102 selects the processor 103 with a smallest number of interrupts from among the processors included in the [list of interrupt inhibiting processors] (step S2455). The processor 102 notifies the processor 103 to change the value of the mask level register 163 from 3 to 2 (step S956).

Next, in step S94, the processor 102 performs the processing for changing the mask level register value on the processor that is to be reassigned as the interrupt permitting processor (step S95).

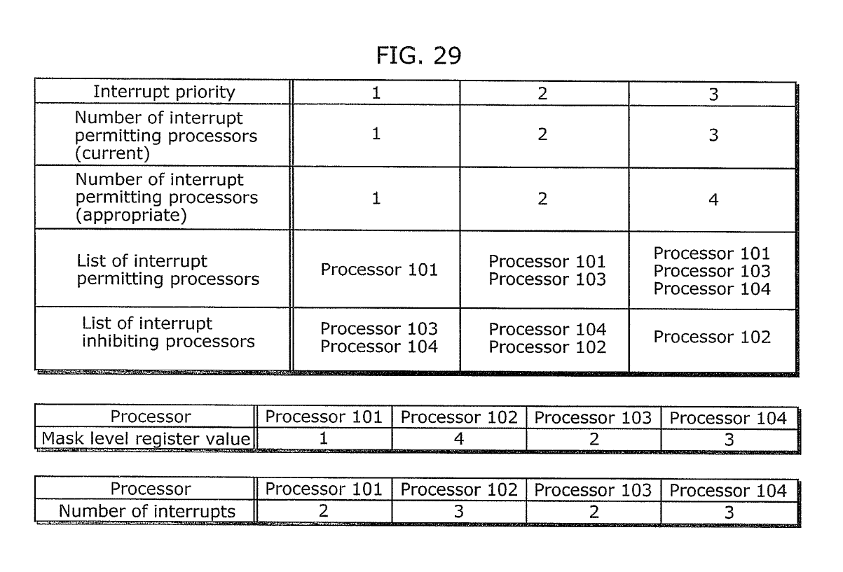

Specifically, in step S95, the processor 103, which has been instructed by the processor 102 to change the interrupt priority value of the mask level register 163, changes the value of the mask level register 163 of the processor 103 itself to 2 (step S951). Next, the processor 102 deletes the processor 103 from the [list of interrupt inhibiting processors] at the designated interrupt priority 2. Then, the processor 102 adds the processor 103 to the [list of interrupt permitting processors], and also adds 1 to the [(current) number of interrupt permitting processors] (step S952). Here, FIG. 29 shows a status of the by-priority number of processors table 700, and the mask level registers 161, 162, 163, and 164 of the processors 101, 102, 103, and 104 immediately after performance of the processing in step S952.

Next, the processor 102 determines, with reference to the by-priority number of processors table 700, whether or not further readjustment of the mask level register is necessary (step S96), and re-performs the processing for reassigning the interrupt permitting processor (step S94).

Specifically, in step S96, since, with reference to the by-priority number of processors table 700, the [(current) number of interrupt permitting processors] and the [(appropriate) number of interrupt permitting processors] do not match at the designated interrupt priority 3 as shown in FIG. 29 (Yes in step S931), the processor 102 performs the processing for reassigning the interrupt permitting processor at the designated interrupt priority 3 (step S94).

In step S94, the processor 102 compares, with reference to the by-priority number of processors table 700, the values of the [(current) number of interrupt permitting processors] and the [(appropriate) number of interrupt permitting processors] at the designated interrupt priority 3. Then, the processor 104 determines whether or not the (current) number of the processors permitting an interrupt is in excess (step S952).

Since, at the designated interrupt priority 3, the [(current) number of interrupt permitting processors] is smaller than the [(appropriate) number of interrupt permitting processors] by 1, the processor 102 determines that the number of processors permitting an interrupt is insufficient (No in step S952). Next, the processor 102 selects the processor 102 with a smallest number of interrupts from among the processors included in the [list of interrupt inhibiting processors] (step S2455), and notifies the processor 102 to change the value of the mask level register 162 to 3 (step S956).

Next, in step S94, the processor 102 performs the processing for changing the mask level register value on the processor that is to be reassigned as the interrupt permitting processor (step S95).

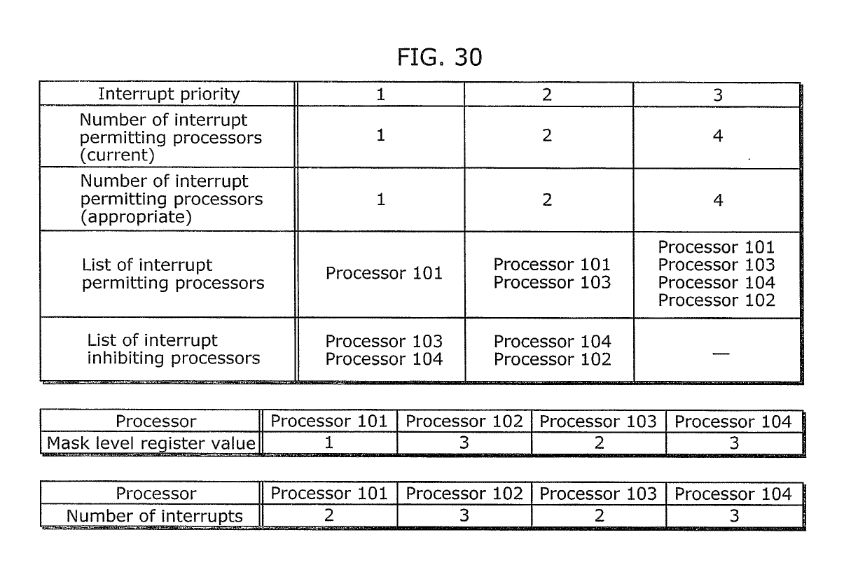

Specifically, in step S95, the processor 102 changes the value of the mask level register 162 of the processor 102 itself to 3 (step S951). Next, the processor 102 deletes the processor 102 from the [list of interrupt inhibiting processors] at the designated interrupt priority 3. Then, the processor 102 adds the processor 102 to the [list of interrupt permitting processors], and also adds 1 to the [(current) number of interrupt permitting processors] (step S952). Here, FIG. 30 shows a status of the by-priority number of processors table 700 and the mask level registers 161, 162, 163, and 164 of the processors 101, 102, 103, and 104 immediately after the processing in step S952.

Next, the processor 102 determines, with reference to the by-priority number of processors table 700, whether or not further readjustment of the mask level register is necessary (step S96). As shown in FIG. 30, since the [(current) number of interrupt permitting processors] and the [(appropriate) number of interrupt permitting is processors] match at all the levels of the designated interrupt priority, the processor 102 determines that readjustment of the mask level register is not necessary (No in step S96) and terminates the processing for changing the number of interrupt permitting processors.

At this time, the value of the mask level register 162 of the processor 102 is set to a value higher than the values of the mask level registers 161 and 163 of the processors 101 and 103, thus suppressing an occurrence of an interrupt in the processor with a larger number of interrupt occurrences.

As described above, the multiprocessor system according to the fourth embodiment performs the processing for changing the number of interrupt permitting processors.

As described thus far, according to the fourth embodiment, it is possible to realize a multiprocessor system interrupt control method for distributing interrupt processing by avoiding a concentration of interrupts in a specific processor.

Note that in the fourth embodiment the processing for reassigning the interrupt permitting processor is performed immediately after obtaining an interrupt processing right, but such processing may also be performed with other arbitrary timing. For example, the processing may be performed after completion of the interrupt processing, may be performed after interrupt processing is performed a predetermined number of times, or may be periodically performed using a timer hander or the like.

As described thus far, according to the multiprocessor system interrupt control method according to the present invention, it is possible to meet a high demand for improved interrupt responsivity in the multiprocessor system and also improve efficiency of the entire system. Accordingly, it is possible to improve the function and reduce power consumption of a microcomputer including a multiprocessor. This allows realizing a multiprocessor system and a multiprocessor system interrupt control method which can improve processing efficiency of the entire system while concurrently securing appropriate interrupt responsivity according to interrupt priority.

As described thus far, a multiprocessor system and a multiprocessor system interrupt control method according to an implementation of the present invention have been described based on embodiments, but the present invention is not limited to such embodiments. Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

For example, in the embodiments of the present invention, an interrupt is notified to the processor from the interrupt generation device 130 via the shared bus 110, but another technique may be used such as including a dedicated signal line.

In addition, although it is particularly preferable to adapt a configuration which allows selecting the interrupt permitting processor according to interrupt priority as described in the embodiments of the present invention, the configuration is not limited to this.

### INDUSTRIAL APPLICABILITY

The present invention is applicable to a multiprocessor system and a multiprocessor system interrupt control method, and is particularly applicable to a multiprocessor system and a multiprocessor system interrupt control method which control an interrupt in a multiprocessor.

What is claimed is:

1. An interrupt control method for a multiprocessor system which includes: a plurality of processors each including a register; a plurality of I/O devices; and an interrupt generation device, said interrupt control method comprising:
setting a mask level value for the register, the mask level value indicating permissibility for an interrupt to be permitted by a corresponding one of the plurality of processors;
receiving an interrupt request from one of the plurality of I/O devices, and notifying, to the plurality of processors, the interrupt request and interrupt priority indicating priority for an interrupt by each of the plurality of I/O devices, said receiving and said notifying being performed by the interrupt generation device holding the interrupt priority in a memory unit; and
accepting the interrupt request, by one of the plurality of processors that includes the register set to a mask level value lower than a value of the interrupt priority.

2. The multiprocessor system interrupt control method according to claim 1, further comprising:
holding, in a memory, a table indicating a first processor number and a second processor number for the interrupt priority of each of the plurality of I/O devices, the first processor number being the number of processors able to accept the interrupt request, and the second processor number being the number of processors that should be able to accept the interrupt request;
changing the second processor number; and
changing, when the second processor number is changed, at least one of the mask level values so that the first processor number matches the changed second processor number.

3. A multiprocessor system which includes: a plurality of processors each including a register; a plurality of I/O devices; and an interrupt generation device, said multiprocessor system further comprising:
a setting unit configured to set a mask level value for said register, the mask level value indicating permissibility for an interrupt to be permitted by a corresponding one of said plurality of processors;
a notifying unit configured to notify an interrupt request and interrupt priority to said plurality of processors, the interrupt request being received from one of said plurality of I/O devices by said interrupt generation device holding the interrupt priority in a memory unit, and the interrupt priority indicating priority for an interrupt by each of said plurality of I/O devices; and
an acceptance unit configured to cause one of said plurality of processors to accept the interrupt request, said one of said plurality of processors including said register set to a mask level value lower than a value of the interrupt priority.

4. The multiprocessor system according to claim 3, further comprising:
a holding unit configured to hold, for the interrupt priority of each of said plurality of I/O devices, a first processor number and a second processor number, the first processor number being the number of processors able to accept the interrupt request, and the second number being the number of processors that should be able to accept the interrupt request;
a changing unit configured to change the second processor number; and
a mask level changing unit configured to change, when the second processor number is changed, at least one of the mask level values so that the first processor number matches the changed second processor number.

5. The multiprocessor system according to claim 4, further comprising:
a task priority holding unit configured to hold task priority for a task to be executed by each of said plurality of processors; and
a task priority changing unit configured to change the task priority according to the task to be executed by each of said plurality of processors,
wherein said changing unit is configured to change the second processor number according to the task priority when the task priority is changed.

6. The multiprocessor system according to claim 4, further comprising:
a task priority holding unit configured to hold an interrupt occurrence frequency for each of said plurality of processors; and
an interrupt occurrence frequency changing unit configured to change the interrupt occurrence frequency according to the number of interrupts executed by each of said plurality of processors,
wherein said changing unit is configured to change the second processor number according to the interrupt occurrence frequency when the interrupt occurrence frequency is changed.

7. An integrated circuit in a multiprocessor system which includes: a plurality of processors each including a register; a plurality of I/O devices; and an interrupt generation device, said integrated circuit comprising:
a setting unit configured to set a mask level value for the register, the mask level value indicating permissibility for an interrupt to be permitted by a corresponding one of the plurality of processors;
a notifying unit configured to notify an interrupt request and interrupt priority to the plurality of processors, the interrupt request being received from one of the plurality of I/O devices by the interrupt generation device holding the interrupt priority in a memory unit, and the interrupt priority indicating priority for an interrupt by each of the plurality of I/O devices; and
an acceptance unit configured to cause one of the plurality of processors to accept the interrupt request, the one of the plurality of processors including the register set to a mask level value lower than a value of the interrupt priority.
